(19) United States
(12) Patent Application Publication
(10) Pub. No.: US 2005/0159092 A1
(43) Pub. Date: Jul. 21, 2005

(54) Uni-Gripp

(76) Inventor: Rueben J. Stanislaw, Jenkintown, PA (US)

Correspondence Address: Rueben J. Stanislaw, 636 Roseland Avenue, Jenkintown, PA, 19046, US

(21) Appl. No.: 11/023,127

(22) Filed: Mar. 21, 2005

Related U.S. Application Data
(60) Provisional application No. 60/532,996, filed on Dec. 29, 2003.

(51) Int. Cl. A22C 29/02; B25B 7/00

(52) U.S. Cl. 452/6; 81/300

(57) ABSTRACT

A versatile utility tool molded of all nylon material in one operation to produce two parts which makes one complete tool that has two handles with serrated jaws and a pick on one handle end with an internal breech type male and female interlocking rotary hinge functioning the tool to open, close, clamp, grip, crack and when handles are pulled apart will separate completely from each other whereupon separation will reveal the internal breech type rotary hinge that dependant upon the tool use will enable if necessary effective hinge cleaning and upon matching rotary hinge internal notches and ears in handles thereby will restore the handles to snap together to become one completed functioning utility tool.

The Uni-Gripp was invented to produce a versatile utility tool item to be used for cracking crab shells and lobster shells. After production, its properties were found to afford the tool to be used in other areas, possibly the fishing, boating and camping industries, the electrical field, medical field and the household.

The Uni-Gripp is made of all nylon material with no metal parts. It has high tensile strength, is light weight and extremely durable. It will not rust, is non-conductive of electricity and is dishwasher safe. For cleanliness, it can be separated into two exposed inernal parts.

The Uni-Gripp can be useful in the fishing, boating and camping industries as there are no metal parts and will be impervious to rust caused by moisture. Withstanding temperatures of 400° degrees Fahrenheit allows the tool to be used in the household for removing hot items and utensils from ovens and stoves. Made of all nylon material, it is non-conductive of electrical current and can be useful to the electrical industry for removing fuses from electrical fuse boxes. It is easily sacked and carried because the size is small and the weight is light. A small pick on one handle end can be used for picking within crab shells and lobster shells and other various purposes.

### OPERATION

A steel mold is machined in high definition precisely and with close tolerance precision. The tool parts defined are produced in a plastic injection molding press. The item is produced in one measure and ejected as two tarts to make the complete tool in one cycle. Thereafter, the two parts are aligned together manually to become the Uni-Gripp tool.

The Uni-Gripp tool mold is mounted in a plastic injection molding press. The mold has a machined upper cavity and lower cavity. The upper half of the mold is made as a male mating cavity. The lower half of the mold is the female mating cavity. Nylon pellets material are fed through a heated injection chamber to a liquid melt temperature and injected by pressure into the mold cavities that will form the two parts of the Uni-Gripp. When the proper cooling time has elapsed, the parts solidify in the mold. The two halves of the mold open and two solid parts are ejected. Each part has notches approximately midway. One part has notches with molded ears. One part has notches with molded slots. There is a flat tip at the end of the jaws. The jaws are arched and have serrated faces. The molded notches will form a rotary interlocking hinge when the ear notches and slot notches are aligned and snap together to form the complete Uni-Gripp tool.

The molded serrated jaws of the Uni-Gripp tool form an arch of various openings to accommodate to various size uses. The flat tip of the jaws will hold items that do not need the larger serrated arch to effect use. The reach of the jaws is determined by the spread of the handles. When handles are fully extended apart, the hinge will not separate until light pressure is applied in the jaw area on the interlocking rotary latch.

To separate, the jaws must be fully extended by expanding the handles. Using light pressure with thumbs and forefingers on the jaws to push one jaw away from the other, the parts will disengage, revealing the internal nothces. (Pulling one handle upward and one handle downward can also effect the same separation).

To unite the handle parts, the ears and the slots of the notches must be aligned to allow the tool to snap together. The two parts of the Uni-Gripp handles will always fit one to another because all the slots and ears will match one to the other. There is neither a left handle or right handle designation. There is no designated top part or bottom part of the Uni-Gripp. When the tool is held separated in two parts, the key to connecting the parts is only by matching the ears and slots of the internal rotary interlocking hinge notches. Therefore, since the handle parts interact with each other according to matching the notches, there is no definition that one is only a pair. Handles can be interchanged by aligning the ears and slots of any handle notches to complete the Uni-Gripp Utility Tool.

### BACKGROUND

Crab and lobster shells have been cracked with metal and wood utensils with certain objectional properties. Metal utensils noted with continued use to possibly become rust prone. Wood utensils possibly become imbedded with food particles, therefore, sanitary issues are raised as to the cleanliness of existing metal and wood utensils. Uni-Gripp addresses the cleanliness issue with its unique property of exposing the nylon rotary hinge and viewing all internal parts that can be cleaned using high temperatures, as well as other methods, safely.

### DRAWING

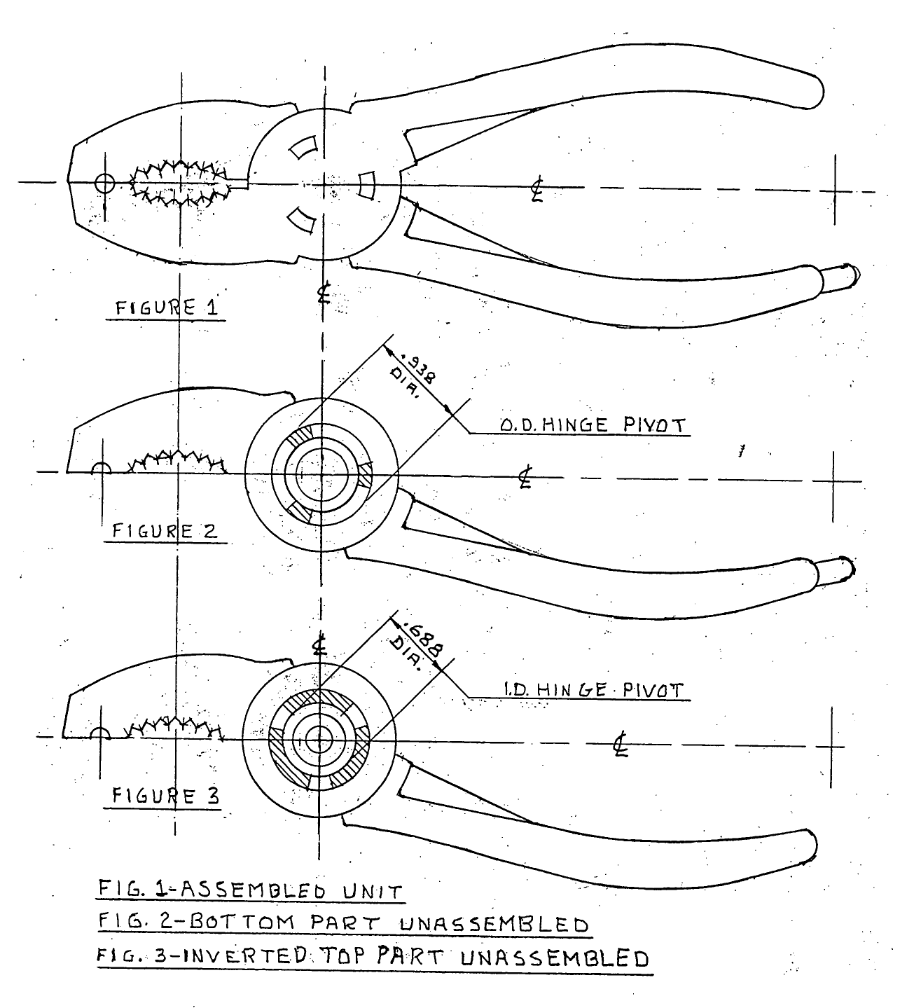

FIG. 1. Uni-Gripp Tool
A. Assembled Unit Complete Tool
B. Closed Position

FIG. 2. Bottom Part Unassembled
A. Flat Tip
B. Serrated Jaw
C. Internal Rotary Interlocking Hinge Pivot
D. Internal Aligning Molded Ears
E. Molded Pick In Handle

FIG. 3. Inverted Top Part Unassembled
A. Flat Tip
B. Serrated Jaw
C. Internal Rotary Interlocking Hinge Pivot
D. Internal Aligning Molded Slots

1. A utility tool comprising:
(a) two handles with serrated jaws with pick on one handle end with means to open, close, clamp, grip, pick, crack and be pulled apart
(b) an internal breech type interlocking rotary hinge to enable said handles means to produce said functions
(c) said handles when pulled apart effect complete separation to expose said internal breech type interlocking rotary hinge
(d) slots and ears of said internal rotary hinge that will align said two handles to snap together to join and close to make one complete tool thereby to function as said utility tool.
